(19) United States
(12) Patent Application Publication
(10) Pub. No.: US 2009/0151159 A1
(43) Pub. Date: Jun. 18, 2009

(54) METHOD FOR ARRANGING A PLURALITY OF CONNECTING ELEMENTS

(75) Inventor: Oug-Ki LEE, Seoul (KR)

Correspondence Address: LEXYOUME IP GROUP, LLC, 5180 PARKSTONE DRIVE, SUITE 175, CHANTILLY, VA, 20151, US

(73) Assignee: PHICOM Corporation, Seoul (KR)

(21) Appl. No.: 12/103,974

(22) Filed: Apr. 16, 2008

(30) Foreign Application Priority Data
Dec. 12, 2007 (KR) 10-2007-0128827
Dec. 12, 2007 (KR) 10-2007-0128831
Dec. 12, 2007 (KR) 10-2007-0128835
Dec. 12, 2007 (KR) 10-2007-0128843
Dec. 12, 2007 (KR) 10-2007-0128847

(51) Int. Cl. H01R 9/00

(52) U.S. Cl. 29/842; 29/876; 29/874; 29/884; 29/885

(57) ABSTRACT

The present invention relates to a method for arranging a plurality of connecting elements corresponding to a plurality of electronic components which is required to be subject to an electric test for inspecting a fault. The method for arranging a plurality of connecting elements on electronic substrates such that the connecting elements may simultaneously contact with a plurality of electronic components comprises the steps of fabricating each connecting element to have the first extending region at one end extended in a certain direction with a regular width and the second extending region at the other end extended in a certain direction with a regular width; and coupling the first extending region of each connecting element to a fixing post formed in a pre-determined region of the electronic substrate in order to be parallel with the second extending region of each connecting element, wherein each of the second extending region extends at the same length.

### TECHNICAL FIELD

The present invention relates to a method for arranging a plurality of connecting elements corresponding to a plurality of electronic components which is required to be subject to an electric test for inspecting a fault. In particular, the present invention relates to the method for arranging a plurality of connecting elements comprising the steps of making contact with an electrode pad electrically connected to a plurality of electronic components arranged on a substrate such as a silicon wafer in order to transfer an electric signal and receive the transferred electric signal in order to detect a fault of a plurality of electronic components.

### BACKGROUND ART

The micro tip structure for testing electronic components is disclosed in prior arts. Semiconductors or microprocessors manufactured in large volume on a silicon wafer should be subject to a fault inspection prior to the individual semiconductor wafer being divided into each element. In order to detect an electric defect of an element, a probe tip associated with a testing device comes into contact with each element and sends input signals to them. The testing device then detects a fault on each element based on response signals from each element. The micro elements are densely fabricated in large volume, thus the testing probe should have sufficiently high density.

Electronic components are mass manufactured in small size. A plurality of electrode pads associated with a plurality of electronic components is arranged in a regular form and every probe should contact with corresponding electrode pads. Various forms of probes designed for inspecting a fault of a plurality of electronic components are disclosed in prior arts. Further, methods for arranging probes depending on each form of probes are also disclosed in prior arts.

WO 2005/085877 discloses a probe assembly wherein probe groups are discontinuously formed in both the x-direction and y-direction. U.S. Pat. No. 7,082,682 discloses contract structures formed by building a core structure on a substrate. US Publication No. 2007/0062913 discloses a probe array made by an electron emitting device. WO 2006/049133 discloses a cantilevered probe by which a stress applied to the beam may be dispersed. The structure and the arrangement of a plurality of probes designed for inspecting a fault of a plurality of electronic components should be determined considering problems may occur due to the size of each electrode pad connecting to each electronic component and the size of each probe. In the prior arts, it is disclosed about a probe structure itself or a probe arrangement only, but they don't specify a probe arrangement correlated with the probe structure. The present invention suggests a method of arranging a plurality of probes relating to a probe structure.

It is an object of the present invention to provide a method of arranging a plurality of connecting elements wherein the connecting elements come into contact with each of electronic pads of a plurality of separated electronic components in order to bring a physically uniform result.

### BRIEF DESCRIPTION OF THE DRAWINGS

FIG. 1a shows an applicable form of the connecting element for an arrangement of electronic components.

FIG. 1b shows of a plurality of electrode pads P corresponding to a plurality of electronic component arranged in a regular form on semiconductor dies S.

FIG. 1c shows an arrangement of such connecting elements corresponding to electrode pads P shown in FIG. 1b.

FIG. 2a shows an embodiment of the structure of arranging the connecting element according to the arrangement of pad in the present invention.

FIG. 2b shows the connecting element of FIG. 2a.

FIG. 3 shows an embodiment of arranging a plurality of connecting elements corresponding to a plurality of electrode pads.

FIG. 4a and 4b show an embodiment of a process of arranging a plurality of connecting elements according to the present invention.

FIG. 5a and 5b show an embodiment of a process of elastic displacement of the connecting element and the positional change of the contact tip thereof.

FIG. 6a shows the method of arranging connecting elements disposed to have the same length of connecting region between the first extending region and the second extending region.

FIG. 6b shows other embodiment of a method of arranging a plurality of connecting elements having the same length of the connecting region.

FIG. 7a shows a front view and a plain view of each connecting element arranged according to the present invention.

FIG. 7b shows a structural change occurring when the connecting element (shown in FIG. 7a) contacts with the electrode pad.

### DISCLOSURE OF THE INVENTION

According to a preferred embodiment of the present invention, a method for arranging a plurality of connecting elements on electronic substrates such that the connecting elements may simultaneously contact with a plurality of electronic components comprises the steps of fabricating each connecting element to have the first extending region at one end extended in a certain direction with a regular width and the second extending region at the other end extended in a certain direction with a regular width; and coupling the first extending region of each connecting element to a fixing post formed in a pre-determined region of the electronic substrate in order to be parallel with the second extending region of each connecting element, wherein each of the second extending region extends at the same length.

According to other preferred embodiment, the method for arranging a plurality of connecting elements on the surface of the first electronic component in order to temporarily make contact with a plurality of electrode pad formed on the second electronic component comprises the steps of dividing a plurality of electrode pad into a plurality of groups according to the arrangement relationship; determining the direction of arranging connecting elements to each group; determining a permitted inclination angle generated by the difference between the arrangement length of connecting elements and the arrangement length of electrode pads; and determining the length of the extending region which extends at a certain length in a certain direction in order to correspond to each electrode pad and the length a connecting region which extends from the extending region towards the fixing post of connecting element, wherein the length of the first extending region and the second extending region of each connecting element and the length of the connecting region are determined in order to minimize the difference of elastic displacement of each contact tip.

According to other preferred embodiment, the method for arranging a plurality of connecting elements corresponding to at least two of each electrode pad comprises the steps of fabricating the connecting element having the first extending region which extends in a certain direction corresponding to the electrode pad and the second extending region which extends in the same direction as the first extending region; fixing at least a part of the first extending region to a pre-determined region of the electrode substrate, wherein the first extending region and the second extending region extend at the same width.

According to other preferred embodiment, the method for arranging a plurality of connecting elements corresponding to a plurality of electrode pads on the electronic substrates comprises the steps of determining the arrangement length of pads corresponding to a plurality of electrode pads and the arrangement length of the elements corresponding to a plurality of connecting elements; drawing a circular arc determined by a line connecting the end of the arrangement length of pads and the end of the arrangement length of elements; fabricating a plurality of connecting elements having the first extending region which is extended in a certain direction corresponding to electrode pads and the second extending region which is extended in the same direction as the first extending region; and arranging at least a part of the first extending region at a pre-determined interval along the circular arc.

According to other preferred embodiment, the method for arranging a plurality of connecting elements in order to electrically connect a plurality of connecting elements having the fixing post coupled to the first electronic component, the beam, the base and the contact tip with each corresponding electrode pad formed on the second electronic component comprises the steps of determining the first extending region and the second extending region having inelastic structure in each connecting element and the connecting region between the first and the second extending regions having elastic structure; and adjusting a factor in determining elastic displacement in order to minimize the difference of elastic displacement of the contact tip caused by the elastic deformation of the connecting region in each connecting element.

Hereinafter, the present invention will be described in detail with reference to drawings and embodiments. These embodiments are provided only for the illustrative purpose, and it should not be construed that the scope of the invention is limited thereto.

The connecting element in this description means an element electrically interconnects two separate electronic components. The connecting element has two connecting parts contactable with each electronic component, and the two connecting parts are firmly coupled to each corresponding electronic component or temporarily contact with them, which means that the connecting parts maintains its state of connection for a certain time enough to transfer or receive electric signals.

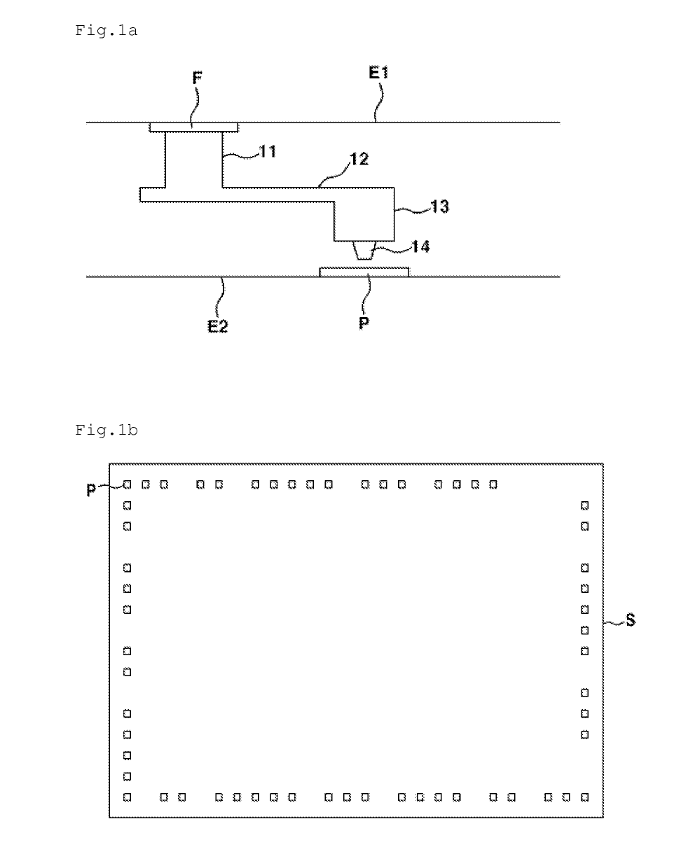

FIG. 1a shows an applicable form of the connecting element for an arrangement of electronic components.

The connecting element detects a fault of the second electronic element E2 by temporarily connecting the first electronic element E1 with the second electronic element E2 and transferring and receiving electric signals. Specifically, the first electronic component E1 may be e.g. a multi-layered composite substrate or a space transformer, a single-layered substrate, a flexible substrate, a membrane substrate, etc., which electrically connects the connecting element with a testing device. The second element E2 may be an integrated circuit (IC) embodied with high density in a semiconductor die formed on a wafer. The connecting element is firmly coupled to a fixing pad F which is formed on the surface of the first electronic component E1 and temporarily contacts with an electrode pad P which is electrically connected with the second electronic component E2 in order to transfer electric signal between the first electronic component E1 and the second electronic component E2. The fixing pad F and the electrode pad P may be positioned either on the same vertical line or on the different vertical line as shown in FIG. 1. The connecting element comprises a fixing post 11 coupled to the fixing pad F; a beam 12 extending from the fixing post 11 towards the electrode pad P; a base 13 extending from the beam 12 towards the electrode pad P in order to determine a contact position of the connecting element; and a contact tip 14 protruding downward from the bottom surface of the base 13 to be contactable temporarily with the electrode pad P. The fixing post 11, the base 13 and the contact tip 14 have inelastic structures and the beam 12 has an elastic structure. In this description, the concept of elastic and inelastic is used relatively and it is assumed the each structure has a restoring force. If the second electronic component E2 approaches towards the first electronic component E1 and reaches the contact tip 14 in order to exert force or pressure to the tip, the contact tip 14 moves towards the first electronic component E1. The contact tip is movable by the elastic deformation of the beam 12 in up and down direction. The contact tip 14 or the fixing post 11 may be fabricated to be elastically deformed in the up and down direction, but the present invention relates to a connecting element wherein the fixing post 11, the base 13 and the contact tip 14 are not subject to elastically deformation in up and down direction due to their own restoring force. In fact, however, the mentioned components (the fixing post 11, the base 13 and the contact tip 14) are elastically deformed, but their degree of deformation is negligible in comparison to the elastic deformation of the beam. Unless stated otherwise, the term of elastic deformation in this description means the elastic deformation in the up and down direction. Therefore, elastic deformation means that if a certain force or pressure is exerted to one point, it causes a relative change in the relationship of the vertical position with other adjacent point. The form of the connecting element may be classified by the relationship between the position of the fixing pad F wherein the fixing post 11 is coupled to the surface of the first electronic component E1 and the position of the electrode pad P formed on the second electronic component E2. The connecting element may be vertically arranged, if the fixing pad F and the electrode pad P are disposed on the same line vertically extending to the surface of first electronic component E1 or the second electronic component E2. Meanwhile, the connecting element may be extendedly arranged, if they are disposed on each different vertical line. The connecting element shown in FIG. 1a is extendedly arranged, but it may be vertically arranged according to the present invention with appropriate variation.

A plurality of electrode pad P may be arranged in various forms on semiconductor dies embodied in a wafer, for example, as shown in the FIG. 1b.

FIG. 1b shows of a plurality of electrode pads P corresponding to a plurality of electronic component arranged in a regular form on semiconductor dies S.

A plurality of electrode pads P are densely-arranged on semiconductor dies S in a regular form. In general, the size of the electrode pad is in the range of 50 to 120 μm, but may be different depending on its density and the type of electronic components. The electrode pad P is not necessarily arranged in a regular form, but in a various form depending on the type of semiconductors. Each electrode pad P is electrically connected with each electronic component and temporarily contacts with each corresponding connecting element. FIG. 1c shows an arrangement of such connecting elements corresponding to electrode pads P shown in FIG. 1b.

Each connecting element 10 is arranged corresponding to each electrode pad P. The electrode pad P may be arranged in a various form and the connecting element should be arranged corresponding to the arrangement of the electrode pad P. During the electric testing of the electrode pad P, the entire connecting elements 10 should be arranged corresponding to each electrode pad P in order to simultaneously contact with the electrode pads P and transfer and receive electric signals and then simultaneously separate therefrom. Further, this process of contact and separation should be repeated for several times until the test for the entire semiconductor dies is completed. In general, the size of the electrode pad P is smaller than the size of the connecting element and the electrode pads P are disposed with high density, thus a structure for arranging a plurality of connecting element which is appropriate for the arrangement of the electrode pad P should be determined.

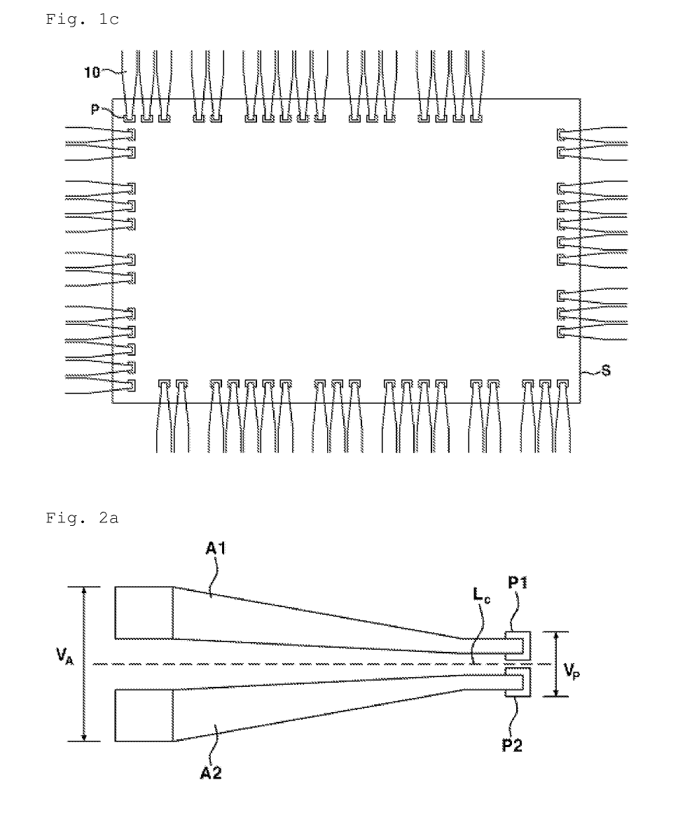

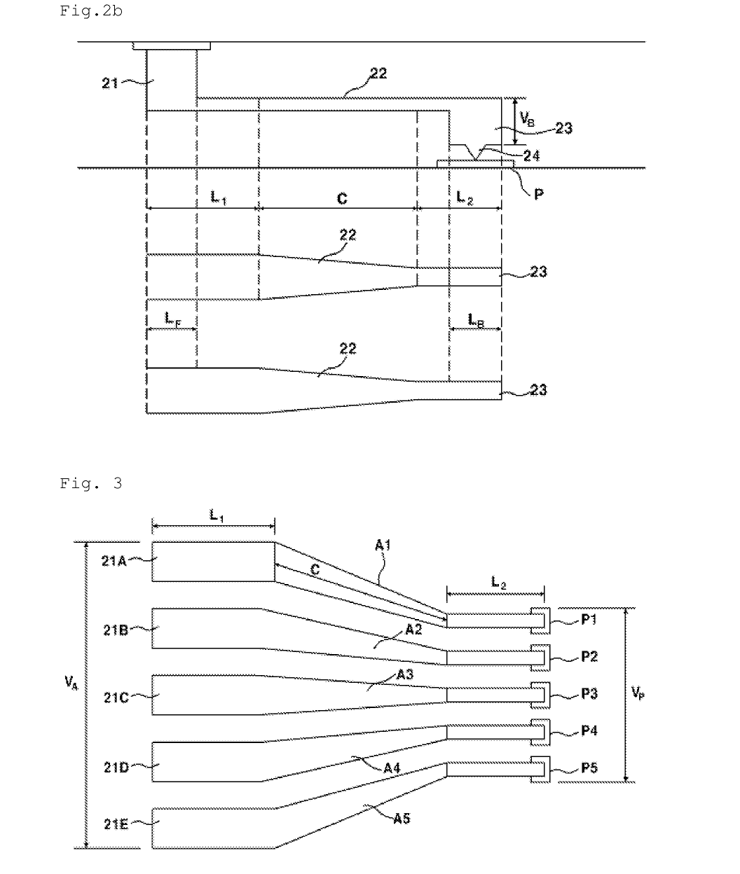

FIG. 2a shows an embodiment of the structure of arranging the connecting element according to the arrangement of pad in the present invention.

The electrode pads P1, P2 (as shown) are two adjacent electrode pads densely disposed on a silicon wafer. Corresponding to the two electrode pads P1, P2, two connecting elements A1, A2 are disposed, and the entire arrangement length V_{P} of the electrode pads P1, P2 (hereinafter, referred to as “the arrangement length of pads” is smaller than the entire arrangement length V_{A} of the connecting elements (hereinafter, referred to as “the arrangement length of elements”. The position of the electrode pads P1, P2 is pre-determined, thus the corresponding connecting elements A1, A2 are fabricated corresponding to the position of the electrode pad P1, P2, thus, for example, should be disposed on an electric substrate such as a space transformer. Typically, the density of the connecting elements A1, A2 is less than that of the electrode pads P1, P2, thus the arrangement length of elements A1, A2 fixed on the electric substrate becomes greater than the arrangement length of pads P1, P2. This difference in length is getting bigger as the number of electrode pad and each corresponding connecting element are increased. Further, the connecting elements A1, A2 are arranged on a separate plane from the electrode pads (P1, P2). The contact tip of the connecting elements A1, A2 contacts with the electrode pads P1, P2 in order to make a scrub and transfer electric signals. It is preferred that the scrub made on each electrode pad P1, P2 has the same position and form in terms of transferring of electric signal and the testing stability. The relative difference in length between the connecting elements A1, A2 and the electrode pads P1, P2 and the separation of the electrode pads P1, P2 from the connecting elements A1, A2, however, make it difficult to make a scrub on the same position and in the same form on each electrode pad P1, P2. In order to make a scrub in the same position and form, the contact tip should be disposed on the same position of the electrode pad, the contact tip having the same form should be pressured in the same amount, and during this pressuring process, the contact tip should move in the same direction maintaining the same contacting region.

The fixing regions of the two connecting elements in the embodiment of the FIG. 2a are symmetrically disposed based on a center line L_{C} of the electrode pad. The interval between the fixing regions of each connecting element may be determined at its minimum in order to prevent any unwanted electric interruption. In addition, it should be considered about the possibility of fabricating a required form. The scrub made on the electrode pads P1, P2 is preferred to be formed in parallel along the center line L_{C}. Therefore, the contacting region of the connecting element is preferred to be arranged in parallel to the direction of the center line, which is shown in FIG. 2b.

FIG. 2b shows the connecting element of FIG. 2a.

As already mentioned above, the connecting element comprises the fixing post 21 coupled to the fixing pad F; the beam 22 horizontally extending from the fixing post 21 to the electrode pad P; the base 23 vertically extending from the beam 22 to the electrode pad P; and the contact tip 24 contacting temporarily with the electrode pad P during the test process. It is necessary to fabricate the beam 22 in a regular form in order that the contact tip 24 contacts with the electrode pad P and makes a scrub in a certain direction. The plane figure of the beam 22 is shown in FIG. 2b (lower).

The beam 22 consists of the first extending region L₁ which couples to the fixing post 21 and extends having the same width and the second extending region L₂ which couples to the base 23 and extends having same with towards the fixing post 21 direction. A connecting region C which connects the first extending region L₁ with the second extending region L₂ doesn't extend with same width. The connecting region C may be formed symmetrically or asymmetrically. The connecting region C is determined by the disposition of the fixing post 21, but the fixing posts 21 should be disposed having minimum intervals in order to prevent any electric interruption, and it is preferred to be formed asymmetrically as the length of vertical element of the fixing post 21 is greater than the arrangement length of electrode pad P. The first extending region L₁ may be shaped same as the contacting region L_{F} of the fixing post 21, preferably may be extending beyond the contacting region L_{F} of the fixing post 21. The second extending region L₂ is also shaped same as the contacting region L_{B} of the base 23, preferably may be extending beyond the contacting region L_{B} of the base 23. The second extending region L₂ may be determined by the extended length of both the contacting region L_{B} of the base 23 and the electrode pad P. If the extended length of the contacting region L_{B} of the base 23 is at least same as that of the electrode pad P, the second extending region L₂ may be shaped same as the contacting region L_{B} of the base 23. Meanwhile, if the extended length of the contacting region L_{B} of the base 23 is smaller than that of the electrode pad P, it is preferred that the second extending region L₂ is extending beyond the electrode pad P. The second extending region L₂ is preferred to be inelastic, but in case of L₂>L_{F}, it is hard to manufacture the entire second extending region L₂ inelastic. It is preferred, however, a part of the second extending region L₂ positioned closer to the electrode pad P has an inelastic structure. If it is fabricated elastically, it is hard to predict a form of scrub and to make the same form of scrub to each of a plurality electrode pad P in real practice. The simplest way to make a part of the second extending region L₂ inelastic is to extend the base 23 downward at a greater thickness than the extending region. For example, the vertically extended length V_{B} of the base 23 may be 1.5 to 10 times, preferably 2 to 5 times as much as the average thickness of the beam 22. The beam 22 is preferred to be made of the same materials, but if necessary, the second extending region L₂ may be determined to be extended beyond e.g. the electrode pad P up to a certain distance and additionally the connecting region C may be determined and made of other materials. In this case, the connecting region C and the second extending region L₂ may be preferably connected in tiers and the second extending region L₂ may be made of inelastic materials or conductive materials having a high modulus of elasticity. It is necessary to extend the length of the first extending region L₁ and the second extending region L₂ beyond the contacting region in order to exert a homogeneous force to the contact tip 24 and make a homogeneous scrub on the electrode pad P. Considering the elastic property change of the beam 22 and a relative position of the contact tip 24 formed on the base 23, however, it is not necessary to extend to the said range. As shown the FIG. 2b (lower), for example, the first extending region L₁ and the second extending region L₂ may be fabricated to have the same length as the contacting region L_{F} of the fixing post 21 and the contacting region L_{B} of the base 23, respectively. Alternatively, it may be applicable in either case of L₁=L_{F} or L₂=L_{B}.

In case of arranging two connecting elements corresponding to two electrode pads P, it is possible to make a scrub having a symmetric structure on each of the electrode pad P, regardless of the length, the direction or the depth of a scrub. According to the length of L₁ or L₂, however, the length, the direction or the depth of each scrub may be varied. In general, in case of arranging tens of connecting elements corresponding to tens of electrode pads, the length of the extending region of the connecting region C between connecting elements may be different, and at the same time, the boundary between the connecting region C and the first extending region L₁ or the second extending region L₂ is inclined. Here, the arrangement of the connecting elements needs to be determined considering the length of the connecting region C and the degree of inclination of the boundary.

FIG. 3 shows an embodiment of arranging a plurality of connecting elements corresponding to a plurality of electrode pads.

For an easier understanding of the present invention, the Figure shows 5 electrode pads, but the number of electrode pads having arrangement relationship may be determined depending on each case. It is not necessary to arrange all of the odd- or even-numbered electrode pads. Further, arrangement relationship means that the structure of the electrode pads is affected by the positional relationship of the electrode pads during the designing or producing process. The five electrode pads (P1, P2, P3, P4, P5) correspond to each five connecting element (A1, A2, A3, A4, A5) and each five connecting element (A1, A2, A3, A4, A5) has the first extending region L₁, the second extending region L₂ and the connecting region C extending with the same width. The arrangement length of pads V_{P} of the five electrode pads (P1, P2, P3, P4, P5) is smaller than the arrangement length of elements V_{A} of the five connecting element (A1, A2, A3, A4, A5). At least a part of the first extending region L₁ and the second extending region L₂ has an inelastic structure and the connecting region C has an elastic structure. A plurality of the first extending region L₁ is parallel to each other and a plurality of the second extending region L₂ is parallel to each other. Furthermore, any of the first extending regions L₁ is parallel to any of the second extending regions L₂. Prior to disposing each of the five connecting element (A1, A2, A3, A4, A5) on the electric substrate, the arrangement length of the elements V_{A} of the five connecting element (A1, A2, A3, A4, A5) corresponding to the arrangement length of pads V_{P} of the five electrode pads (P1, P2, P3, P4, P5) should be determined. The contacting region of the fixing post of each connecting element may be determined to have its minimum interval in order to prevent any electric interruption between the connecting element (A1, A2, A3, A4, A5). Since the arrangement length of the elements V_{A} of the connecting element (A1, A2, A3, A4, A5) is greater than the arrangement length of pads V_{P} of the electrode pads (P1, P2, P3, P4, P5), the connecting region C of each of the connecting element (A1, A2, A3, A4, A5) may not be parallel to each other. In order to efficiently dispose the connecting element (A1, A2, A3, A4, A5), the position for arranging a connecting element A3 corresponding to the electrode pad P3 in the middle is determined first. If the entire electrode pad is even-numbered, a basis for arranging the elements may be the two electrode elements in the middle. As described above relating to the FIG. 2b, the connecting element A3 arranged in the middle has the first extending region L₁ being coupled to the fixing post of the connecting element and the second extending region L₂ being coupled to the base. The first extending region L₁ is positioned closer to the fixing post and the second extending region L₂ is positioned closer to the electrode pad.

On the basis of the connecting element A3 in the middle, the rest of connecting elements (A1, A2, A4, A5) may be arranged symmetrically, but each connecting region C are not parallel to each other. Likewise, a plurality of connecting elements which are arranged symmetrically but not parallel to each other have an inclined boundary of the connecting region C and each of the length of the connecting region C is not same. In this case, the inclination angle of the boundary of each connecting region C and the length of the connecting region C may be determined based on the shape of the scrub made on each electrode pad.

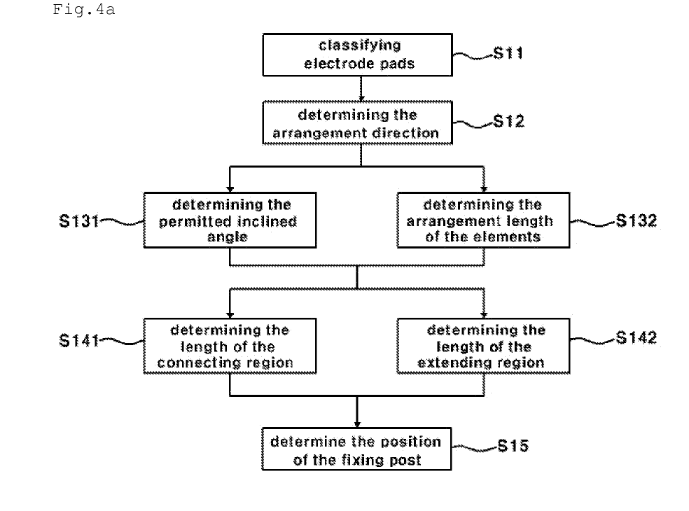

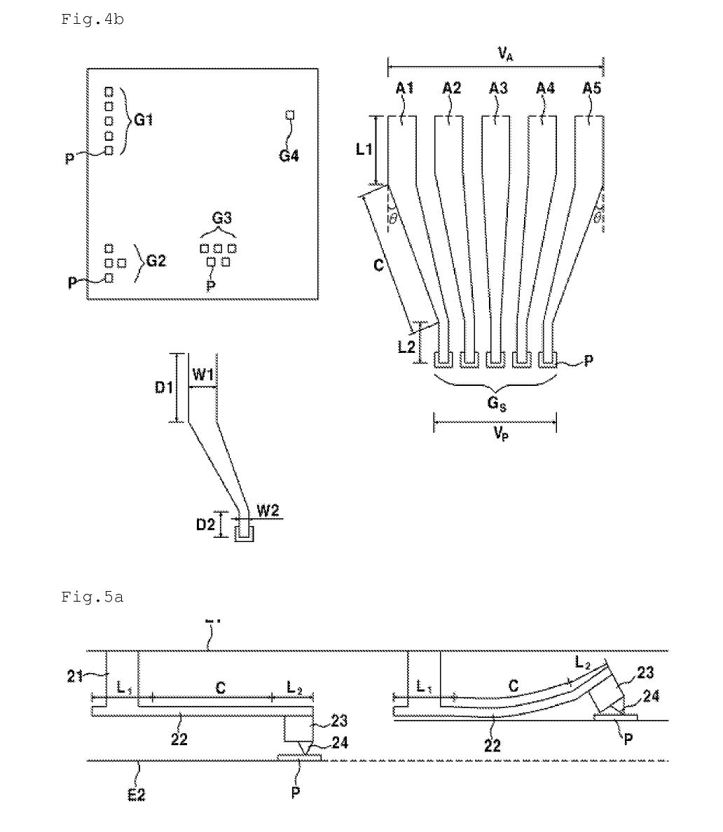

FIG. 4a and 4b show an embodiment of a process of arranging a plurality of connecting elements according to the present invention.

In order to determine the method of arranging a plurality of connecting elements, a plurality of electrode pad P electrically connected to electronic components subject to be under test and formed on semiconductor dies should be classified to have the arrangement relationship (S11). This means that the connecting elements corresponding to a plurality of electrode pad are homogeneously positioned and structured as shown in FIG. 4b. Electrode pads P having such relationship may be divided into four groups (G1, G2, G3, G4) and each group includes at least one electrode pad P. Once the electrode pads P are divided into each group (G1, G2, G3, G4), the number of connecting elements corresponding to the number of the electrode pads P included in each group (G1, G2, G3, G4) and the direction of arranging the connecting elements may be determined (S12). The connecting elements corresponding to the electrode pad P included in each group (G1, G2, G3, G4) may be arranged in the same or different direction. Once the direction of arranging the connecting elements is determined (S12), the arrangement length of the elements V_{A} of the connecting elements (A1, A2, A3, A4, A5) is determined (S132). The arrangement length of the elements V_{A} is determined by the contacting region designed for coupling the fixing post of the connecting elements (A1, A2, A3, A4, A5) with electronic components. Here, the connecting elements (A1, A2, A3, A4, A5) correspond to the electrode pads (P1, P2, P3, P4, P5) included the same group G_{S}. At the same time, a permitted inclined angle θ of connecting elements positioned at both ends A1, A5 is determined (S131), due to the limitation of the manufacturing process or the structure of the connecting element. As shown in FIG. 4b, the permitted inclined angle θ means an angle formed between an extending line of the first extending region L1 and the connecting region C. The permitted inclined angle θ may be varied depending on the manufacturing process and structure. The permitted inclined angle θ may be in the range of 0 to 45 degrees, preferably 0 to 25 degrees. Once the arrangement length of the elements V_{A} and the permitted inclined angle θ according to the number of connecting elements (A1, A2, A3, A4, A5) are determined, the length of the connecting region C corresponding to each connecting elements (A1, A2, A3, A4, A5) is determined (S141). Thereafter, the length of the first extending region L₁ and the second extending region L₂ are determined (S142). As described above, the first extending region L₁ and the second extending region L₂ are parallel to each other and extended corresponding to the direction of arranging the electrode pad P. Further, the first extending region L₁ and the second extending region L₂ may be extended with the same width. Each of the first extending region L₁ corresponding to each connecting elements (A1, A2, A3, A4, A5) may be extended at the same distance D₁ with the same width W₁ against each other. Each of the second extending region L₂ is extended in the same manner as the first extending region L₁, but applicable under a certain condition (W₂<W₁; and D₂<D₁).

After each of the length of connecting region C and the extending regions L₁, L₂ is determined, the position of the fixing post is determined (S15). The position of the fixing post corresponding to each connecting elements (A1, A2, A3, A4, A5) may be determined along the same straight line or the same circular arc as described below. According to the above steps of arranging the connecting elements corresponding to each group (G1, G2, G3, G4), the coupling position to an electronic substrate, e.g. a space transformer, is determined. Further, the method of arranging connecting elements corresponding to the entire electronic components subject to the test is determined, and accordingly, the entire connecting elements may be arranged regularly based on the method.

As described above, the first and the second extending regions are extended with the same width. The first extending region, however, having each different connecting element, may be extended at each different length or with different width. The second extending region, also having each different connecting element, may be extended at each different length or with different width. The length and width of the first and the second extending regions of each of connecting element is determined by the elastic displacement of the contact tip of each connecting element.

FIG. 5a shows an embodiment of the connecting element which is elastically deformed by the pressure of the second electronic component after being contact with the electrode pad of the second electronic component. FIG. 5b schematically shows the elastic deformation of the extending region according to the process in FIG. 5a and the positional change of the contact tip therefrom.

The connecting element is firmly coupled to the first electronic component E1 and temporarily contacts with the electrode pad P formed on the surface of the second electronic component E2. In case of testing a plurality of the second electronic components with a plurality of connecting elements simultaneously, the connecting elements may not contact with a plurality of electrode pad P simultaneously, due to errors in height between the connecting elements. Thus, as shown in FIG. 5a (left, right), after the connecting element initially contacts with the electrode pad P, the second electronic component E2 should move towards the first electronic component E1 at a certain distance. This process is necessary to make a regular-size of scrub on the oxidation layer formed on the top of the electrode pad P.

As described above, the connecting element consists of the first extending region L₁, the second extending region L₂ and the connecting region C. Here, the two extending regions are included in an inelastic region and the connecting region is included in elastic region. If the second electronic component E2 moves towards the first electronic component E1, the contact tip 24 initially makes contact with the electrode pad P, and then if the second electronic component E2 keeps moving, overdrive occur, and the elastic connecting region C elastically is deformed. As a result, the contact tip 24 moves in horizontal and vertical directions as shown in FIG. 5a (right). The fixing post 21, the base 23 and the contact tip 24 may be subject to elastic deformation, but if the degree is negligible compared to the elastic deformation of the connecting region C, it may be assumed that the fixing post 21, the base 23 and the contact tip 24 are not elastically deformed. The elastic deformation of the connecting region C caused by the over drive and the change in position of the contact tip 24 therefrom are shown in FIG. 5b. As shown in FIG. 5b, as a result of deformation of the connecting region C, the contact tip 24 moves its position from the initial position T_{I} to the final position T_{F} and accordingly, it moves in the horizontal and vertical directions with the horizontal elastic displacement D_{H} and the vertical elastic displacement D_{V}. In this description, the elastic displacement means a positional change of the contact tip 24 due to elastic deformation of the elastic region, and it includes the horizontal elastic displacement D_{H} and the vertical elastic displacement D_{V}. The size of elastic displacement may be varied due to various reasons. A factor in determining the elastic displacement means something causing the elastic displacement, which may include e.g. the vertically extended length of the contact tip 24, the width and the extended length of the first extending region L₁ and the second extending region L₂, the length of the connecting region C, the modulus of elasticity or bending strength of each part of the connecting element, the structure of the connecting element and the thickness of each part of the connecting element. In general, the horizontal elastic displacement D_{H} determines the length of scrub and the vertical elastic displacement D_{V} relates to the limit of the length of vertically extended length of the fixing post 21 or the complementation of errors in height between the connecting elements. If the horizontal elastic displacement D_{H} is same between connecting elements, the same length of scrub may be made. Therefore, the horizontal elastic displacement D_{H} should be the same in order that each different connecting element makes a scrub having the same length. In real practice, however, the same form of horizontal elastic displacement D_{H} makes difference even in the case of using connecting elements having the same structure. The connecting element arranged on the same electronic substrate is preferred to have the same horizontal elastic displacement D_{H}, but errors may occur more or less in real practice. Thus, it is necessary to minimize the horizontal elastic displacement D_{H} of the connecting elements arranged on the same substrate. Further, the vertical elastic displacement D_{V} between connecting elements is preferred to have smaller errors. The elastic displacement is determined by the factors causing elastic displacement, thus, the smaller the difference between the causing factors, the smaller the elastic displacement. Overall, the connecting elements disposed on the same electronic substrate should be arranged in order to minimize the factors in determining elastic deformation.

In order to minimize the elastic displacement between connecting elements, the first connecting region of each connecting element may be disposed in parallel to each other. Further, the connecting element may be disposed on the surface of the first electronic substrate to have the same width or the same length of the first extending region, which may be applicable to the second extending region. In case of arranging a plurality of connecting elements, however, the width or length of each connecting element may not be the same. In this case, the structural difference of the connecting region C between each connecting element should be minimized. In case of arranging a plurality of connecting elements, the difference of elastic displacement or the factors in determining elastic deformation should be minimized as described in below embodiment.

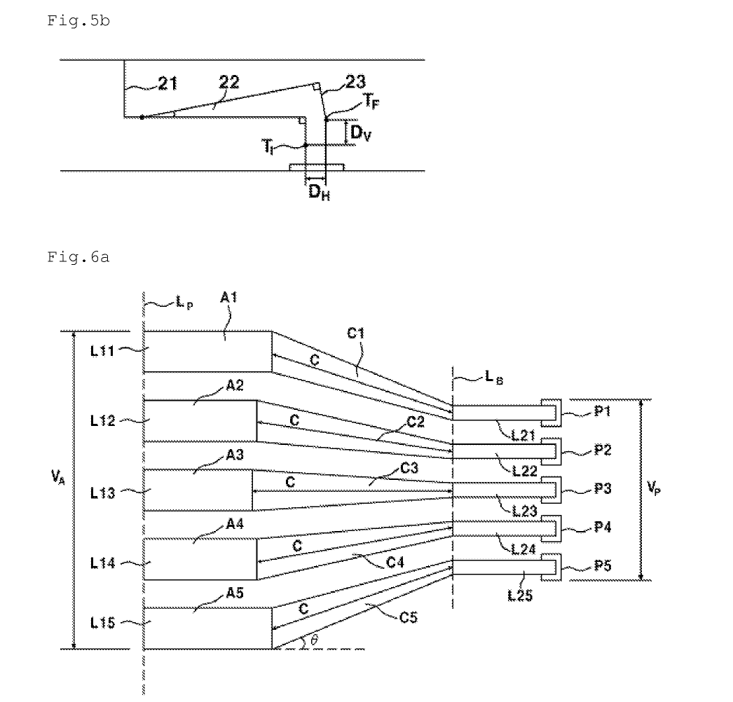

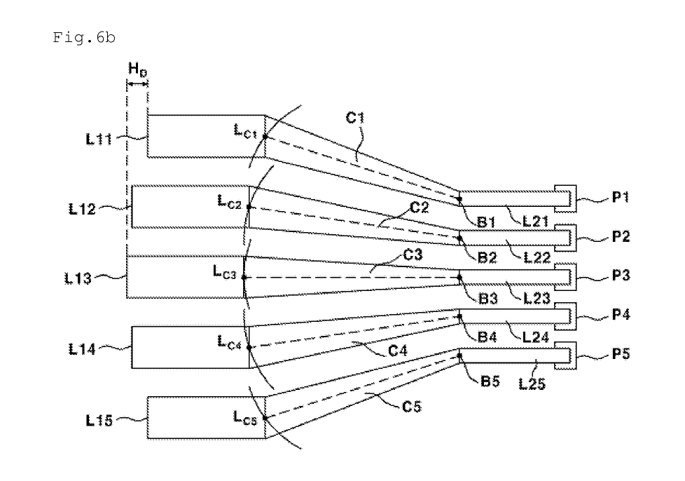

FIG. 6a shows the method of arranging connecting elements disposed to have the same length of connecting region between the first extending region and the second extending region.

Each connecting element (A1, A2, A3, A4, A5) corresponds to each electrode pad (P1, P2, P3, P4, P5) arranged with certain interval. The arrangement length of element V_{A} of the connecting element (A1, A2, A3, A4, A5) corresponding to the arrangement length of pad V_{P} of the electrode pad (P1, P2, P3, P4, P5) is determined. And then the permitted angle 0 of the connecting element A5 positioned at outer end is determined. After each length of the connecting region (C1, C2, C3, C4, C5), the first extending region (L11, L12, L13, L14, L15) and the second extending region (L21, L22, L23, L24, L25) is determined, a position where the fixing post of each of connecting element should be coupled on the surface of the first electronic component is determined. In order to minimize the difference of elastic displacement of each element, each of the second extending regions (L21, L22, L23, L24, L25) should be extended with the same width and length first. And the first extended region (L11, L12, L13, L14, L15) should be extended in parallel with the same width. The left portion of the fixing post (not shown) of each connecting element (A1, A2, A3, A4, A5) is located on the base line L_{P} of the fixing post. The left portion of the second extending region (L21, L22, L23, L24, L25) is located on the base line L_{B} of the base. As described above, the elastic displacement is determined by a factor in determining elastic deformation. In case of the embodiment shown in FIG. 6a, the elastic displacement between each connecting element (A1, A2, A3, A4, A5) is minimized due to the length of connecting region (C1, C2, C3, C4, C5) as a factor in determining elastic deformation. The length of connecting region (C1, C2, C3, C4, C5) of each connecting element is set to be the same and then the length of the first extending region (L11, L12, L13, L14, L15) of each connecting element is determined. Likewise, among the factors in determining elastic deformation, if the length of connecting region (C1, C2, C3, C4, C5) is adjusted to be the same, the relationship of each length of the beam of the connecting element is as follows.

L21=L22=L23=L24=L25 (the length of the second extending region)

C1=C2=C3=C4=C5 (the length of the connecting region)

L11 32 L15>L12=L14>L13 (the length of the first extending region)

Force or torque exerted to the contact tip of each connecting element may a factor in determining elastic deformation. In order to adjust force of torque applied to the second extending region (L21, L22, L23, L24, L25) of each connecting element, the width or thickness of the first extending region (L11, L12, L13, L14, L15) may be adjusted. This process, however, has a disadvantage that it is difficult to adjust relative ratio of width or thickness to each connecting element. If the width of the second extending region (L21, L22, L23, L24, L25) is adjusted smaller, the basis position for rotating torque of the contact tip or the base is advantageously at the boundary between the connecting region (C1, C2, C3, C4, C5) of each connecting element and the second extending region (L21, L22, L23, L24, L25). In order to locate the center of the rotation axis of torque at the boundary between the connecting region (C1, C2, C3, C4, C5) of each connecting element and the second extending region (L21, L22, L23, L24, L25), the width of the connecting region (C1, C2, C3, C4, C5) may be same as the width of the first extending region (L11, L12, L13, L14, L15). In this case, the width of the connecting region (C1, C2, C3, C4, C5) may be narrower at the boundary of the second extending region (L21, L22, L23, L24, L25). Considering that the first extending region of the connecting element is arranged at its minimal interval, however, it has a disadvantage that it is hard to secure a minimum interval capable of preventing electric interruption between the connecting region (C1, C2, C3, C4, C5) near the second extending region (L21, L22, L23, L24, L25). FIG. 6b shows other embodiment of each connecting element having the same length of connecting region (C1, C2, C3, C4, C5).

FIG. 6b shows other embodiment of a method of arranging a plurality of connecting elements having the same length of the connecting region.

A process of determining the position of the fixing post of each connecting element on the surface of the first electronic component is same as described above.

It is assumed that a plurality of electrode pad (P1, P2, P3, P4, P5) is positioned on the same line in the vertical direction. If a plurality of electrode pad (P1, P2, P3, P4, P5) is positioned on different vertical lines, the position of fixing post of each connecting element may be different from the position described in FIG. 6b, but eventually applied by the same principle.

As described above, the second extending region (L21, L22, L23, L24, L25) which makes a scrub on the electrode pad (P1, P2, P3, P4, P5) extends in parallel to each other having the same width and length. Thus, each basis point (B1, B2, B3, B4, B5) of the second extending region (L21, L22, L23, L24, L25) is positioned on the same vertical line. In order to exert the same torque to the contact tip of each connecting element, the connecting region (C1, C2, C3, C4, C5) extends at the same distance from each basis point (B1, B2, B3, B4, B5). The vertical position and vertical length of the fixing post of each connecting element are determined on the surface of the first electronic component. The connecting region C3 of the middle connecting element and its fixing post are positioned on the extending line of the second extending region L23 of the middle connecting element. Once the limiting point L_{C3} which determines the connecting region of the middle connecting element is determined, the length of the middle connecting element C3 becomes the distance from the basis point B3 to the limiting point L_{C3}. Each length of connecting region (C1, C2, C4, C5) of other connecting elements may be determined from each basis point (B1, B2, B4, B5). For example, the length of connecting region C2 of the second connecting element is determined, assuming that its end is located on a circular arc which is drawn based on the second basis point B2 as its center point and with a radius equal to the distance from the basis point B3 of the middle connecting element to its limiting point L_{C3}. In this manner, the position of the connecting region (C1, C2, C4, C5) of each connecting element is determined.

Alternatively, the connecting region of each connecting element may be schematically determined. Once the length of connecting region C3 of the middle connecting element is determined, each length of connecting regions C1, C5 of the most outer connecting elements is determined by their basis points B1, B5. Further, the difference of horizontal distance H_{D} between the middle connecting element and the most outer connecting element is determined. The length of the connecting region C2, C4 of other connecting elements may be determined by proportional allotment of the difference of horizontal distance H_{D}.

According to the method described above, the length of connecting region (C1, C2, C3, C4, C5) of each connecting element is determined and then the length of the first connecting region (L11, L12, L13, L14, L15) is determined. The first connecting region (L11, L12, L13, L14, L15) of each connecting element may be parallel to each other having the same length. Further, the first connecting region (L11, L12, L13, L14, L15) of each connecting element extends at a regular width. Such connecting element may exert homogeneous force or torque to each electrode pad regardless of a form of arrangement of the electrode pad, and thereby makes possible to make same form of scrub.

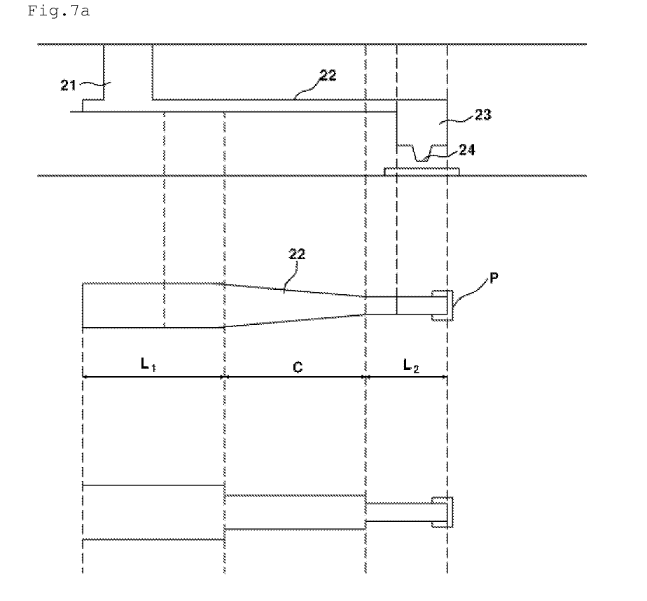

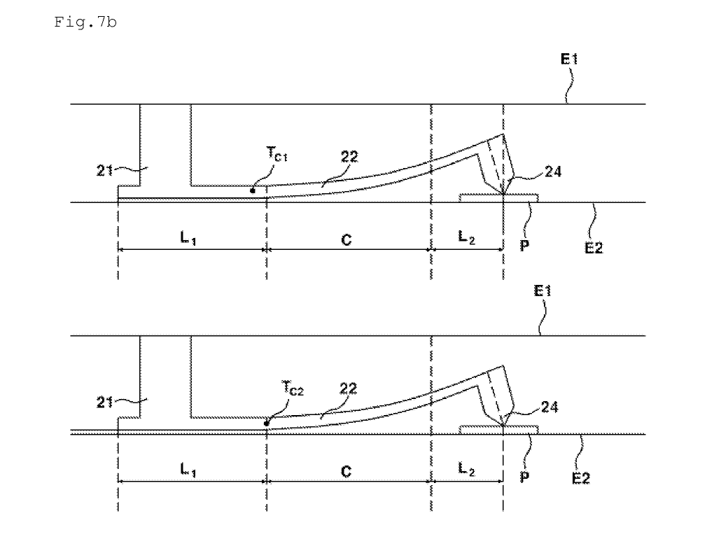

FIG. 7a shows a front view and a plain view of each connecting element arranged according to the present invention.

As shown in FIG. 7a (upper), the connecting element comprises the fixing post 21, the beam 22, the base 23 and the contact tip 24 and the beam 22 consists of the first extending region L1, the connecting region C and the second extending region L2. The first extending region L1 extends beyond the boundary (dotted line) where the fixing post 21 is coupled to the beam 22, and the second extending region L2 extends beyond the boundary where the beam 22 is coupled to the base 23. It is not shown but the first extending region L1 and the connecting region C may have a different thickness and the connecting region C and the second extending region L2 may have a different thickness. Further, as shown in FIG. 7a (middle) the connecting region C may have a different width along the horizontal direction. Alternatively, as shown in FIG. 7a (lower) the connecting region C may extend with the same width. According to an embodiment shown FIG. 7a (lower), the basis position of elastic deformation or the rotating axis of torque of the beam 22 becomes the boundary of the first extending region L1 and the connecting region C. Meanwhile, according to an embodiment shown FIG. 7a (upper), the basis position of elastic deformation or the rotating axis of torque of the beam 22 may move a little towards the fixing post 21, compared to the embodiment shown in FIG. 7a (lower).

FIG. 7b shows a structural change occurring when the connecting element (shown in FIG. 7a) contacts with the electrode pad. The connecting element shown in FIG. 7b (upper) corresponds to the connecting element shown in FIG. 7a (middle) and the connecting element shown in FIG. 7b (lower) corresponds to the connecting element shown in FIG. 7a (lower).

At least a part of the first extending region L1 of the connecting element is not elastically deformed in up and down direction. In an embodiment shown in FIG. 7b (upper), the beam 22 elastically deforms based on the first central axis T_{C1}, and the second extending region L2 is not elastically deformed. Compared to this, in an embodiment shown in FIG. 7b (lower), the beam 22 elastically deforms based on the second central axis T_{C2} formed at the boundary of the first extending region L1 and the connecting region C, and the first extending region L1 is not elastically deformed. When the beam 22 elastically deforms based on the first central axis T_{C1} and the second central axis T_{C2}, the elastic displacement of the contact tip 24 may be different.

If the factors in determining elastic deformation such as the length of the connecting region of a plurality of connecting element supposed to contact simultaneously, the change in width depending on the length of the connecting region and the thickness and materials are all same, the basis position of elastic deformation or the central position of the torque of the beam 22 is same. Thus, in terms of minimizing the difference of elastic displacement, it is not important where the basis position of elastic deformation is determined in a connecting element. Considering the form of scrub made on each electrode pad, however, the base position of elastic deformation is important. For example, if the vertical elastic displacement and horizontal elastic displacement are different according to the basis position of elastic deformation, the basis position of elastic deformation may be determined in order to minimize the vertical elastic displacement and horizontal elastic displacement. If the length of scrub is considered only, the basis position of elastic deformation may be determined based on the horizontal elastic displacement.

There are various factors in determining elastic displacement which determines the elastic displacement of the contact tip. In case of arranging a plurality of connecting elements, a part where connecting elements are arranged homogeneously and the other part where connecting elements are arranged inhomogeneously are determined. Further, the difference of elastic displacement of each contact tip may be minimized by minimizing the difference of factors in determining elastic displacement relating to the part where connecting elements are arranged inhomogeneously. In an embodiment shown in FIG. 6a, the connecting region of each connecting element is formed differently to each other. Thus, the extending length of the connecting region as a factor in determining elastic displacement is same as each connecting element, as a result, minimizing the difference of elastic displacement of the contact tip to each connecting element. Here, the factor in determining elastic displacement may include the ratio of the width to the unit length of the connecting region. Likewise, the difference of elastic displacement may be minimized by adjusting various factors in determining elastic displacement.

It is a clear that the connecting element having a beam which is advantageously divided into the first extending region and the second extending region. By determining the length of the first extending region and the second extending region as pre-determined, the factor in determining elastic displacement relating to the first extending region and the second extending region may be the same. Further, the factor in determining elastic displacement relating to the connecting region may be determined to be same in each connecting element. Thus, the difference of elastic deformation to each different group of electrode pad may be minimized. Further, by making at least a part inelastic, the basis point for elastic deformation of each connecting element is determined to be the same. As a result, by exerting homogeneous force or torque to the contact tip which contacts with the electrode pad, it may be possible to make a desirable scrub having the same form on each electrode pad. Further, by choosing the modulus of elasticity or bending strength of the materials of the beam, it may be possible that the contact tip has an elastic displacement. As a result, it may be possible to expect the form of scrub to be made on each electrode pad.

### Effects of Invention

According to the method of the present invention, a plurality of connecting elements may make a homogeneous form of scrub on a plurality of electrode pads. Accordingly, it has an advantage of increasing the credibility of the test by the method in case of simultaneously testing a plurality of electronic components.

1. A method for arranging a plurality of connecting elements on an electronic substrate such that the connecting elements may simultaneously contact with a plurality of electronic components, comprising the steps of:
fabricating each connecting element to have the first extending region at one end extended in a certain direction with a regular width and the second extending region at the other end extended in a certain direction with a regular width; and
coupling the first extending region of each connecting element to a fixing post formed in a pre-determined region of the electronic substrate in order to be parallel with the second extending region of each connecting element,
wherein each of the second extending region extends at the same length.

2. The method for arranging a plurality of connecting elements according to claim 1, wherein the each connecting element further includes the connecting region which connects the first extending region with the second extending region.

3. The method for arranging a plurality of connecting elements according to claim 2, wherein each of the connecting regions of a plurality of connecting elements has the same length.

4. The method for arranging a plurality of connecting elements according to claim 1, wherein each of the first extending regions has the same length.

5. The method for arranging a plurality of connecting elements according to claim 4, wherein each connecting element further includes the connecting region which connects the first extending region with the second extending region, and each of the connecting region has the same length.

6. The method for arranging a plurality of connecting elements according to claim 1, wherein the first extending region and the second extending region have the inelastic structure.

7. The method for arranging a plurality of connecting elements on the surface of the first electronic component in order to temporarily make contact with a plurality of electrode pad formed on the second electronic component, comprising the steps of:
dividing a plurality of electrode pad into a plurality of groups according to the arrangement relationship;
determining the direction of arranging connecting elements to each group;
determining a permitted inclination angle generated by the difference between the arrangement length of connecting elements and the arrangement length of electrode pads; and
determining the length of the extending region which extends at a certain length in a certain direction in order to correspond to each electrode pad and the length a connecting region which extends from the extending region towards the fixing post of connecting element,
wherein the length of the first extending region and the second extending region of each connecting element and the length of the connecting region are determined in order to minimize the difference of elastic displacement of each contact tip.

8. The method for arranging a plurality of connecting elements according to claim 7, wherein each of the connecting regions of connecting elements has the same length.

9. The method for arranging a plurality of connecting elements according to claim 7, wherein each of the first extending regions of connecting elements has the same length.

10. The method for arranging a plurality of connecting elements according to claim 8, wherein each of the second extending regions of a plurality of connecting elements has the same length.

11. The method for arranging a plurality of connecting elements according to claim 9, wherein each of the connecting regions of connecting elements has the same length.

12. The method for arranging a plurality of connecting elements according to claim 7, wherein at least a part of the first extending region and the second extending region has the inelastic region.

13. A method for arranging a plurality of connecting elements corresponding to at least two of each electrode pad, the method comprising:
fabricating a plurality of connecting elements, each connecting element having the first extending region which extends with the same width in a direction corresponding to the electrode pad, the second extending region which extends with the same width in the same direction as the first extending region, and a connecting region connecting the first extending region with the second extending region,
wherein the first extending region, the second extending region and the connecting region has substantially the same height; and
fixing at least a part of the first extending region to a pre-determined region of an electrode substrate,
wherein a inclined angle at a boundary between the connecting region and the first extending region or the second extending region is determined by a difference between an arrangement length of at least two of electrode pad and an arrangement length of the connecting elements.

14. (canceled)

15. The method for arranging a plurality of connecting elements according to claim 14, wherein each of the connecting regions of a plurality of connecting elements has the same length.

16. The method for arranging a plurality of connecting elements according to claim 13, wherein each of the second extending regions a plurality of connecting elements has the same length.

17. The method for arranging a plurality of connecting elements according to claim 13, wherein at least a part of the first extending region and the second extending region has the inelastic structure.

18. The method for arranging a plurality of connecting elements according to claim 13, wherein the connecting region has the elastic structure.

19. The method for arranging a plurality of connecting elements corresponding to a plurality of electrode pads on the electronic substrates, comprising the steps of:
determining the arrangement length of pads corresponding to a plurality of electrode pads and the arrangement length of elements corresponding to a plurality of connecting elements;
drawing a circular arc determined by a line connecting the end of the arrangement length of pads and the end of the arrangement length of elements;
fabricating a plurality of connecting elements having the first extending region which is extended in a certain direction corresponding to electrode pads and the second extending region which is extended in the same direction as the first extending region; and
arranging at least a part of the first extending region at a pre-determined interval along the circular arc.

20. The method for arranging a plurality of connecting elements according to claim 19, wherein each the connecting element further includes the connecting region which connects the first extending region with the second extending region is included.

21. The method for arranging a plurality of connecting elements according to claim 20, wherein each of the connecting regions of a plurality of connecting elements has the same length.

22. The method for arranging a plurality of connecting elements according to claim 19, wherein each of the second extending regions of a plurality of connecting elements has the same length.

23. The method for arranging a plurality of connecting elements according to claim 19, wherein at least a part of the first extending region and the second extending region has the inelastic structure, and the connecting region has the elastic structure.

24. The method for arranging a plurality of connecting elements according to claim 19, wherein each of the first extending regions has the same width.

25. The method for arranging a plurality of connecting elements according to claim 19, wherein each of the first extending regions has different width.

26. The method for arranging a plurality of connecting elements in order to electrically connect a plurality of connecting elements having the fixing post coupled to the first electronic component, the beam, the base and the contact tip with each corresponding electrode pad formed on the second electronic component, comprising the steps of:
determining the first extending region having an inelastic structure, the second extending region with the same width and distance against each other and the connecting region between the first and the second extending regions having elastic structure; and adjusting a factor in determining elastic displacement in order to minimize the difference of elastic displacement of the contact tip caused by the elastic deformation of the connecting region in each connecting element.

27. The method for arranging a plurality of connecting elements according to claim 26, wherein the elastic displacement includes both horizontal and vertical elastic displacements and the factors in determining elastic displacement are adjusted in order to minimize the horizontal elastic displacement to each connecting element.

28. The method for arranging a plurality of connecting elements according to claim 26, wherein the factors in determining elastic displacement include the vertically extended length of the contact tip, the width and the extended length of the first extending region and the second extending region, the length of the connecting region, bending strength of the connecting element and the thickness of the connecting element.

29. The method for arranging a plurality of connecting elements according to claim 26, wherein the factor in determining elastic displacement is the length of the connecting region.

30. The method for arranging a plurality of connecting elements according to claim 29, wherein each of the connecting regions of a plurality of connecting elements has the same length.

31. The method for arranging a plurality of connecting elements according to claim 26, wherein each of the first extending region of a plurality of connecting elements extends at the same distance and width.

32. The method for arranging a plurality of connecting elements according to claim 26, wherein at least a part of the first extending region and the second extending region has the inelastic structure.

33. The method for arranging a plurality of connecting elements according to claim 13, wherein the width of the first extending region is larger than the width of the second extending region.
